(19) United States
(12) Patent Application Publication
(10) Pub. No.: US 2011/0253810 A1
(43) Pub. Date: Oct. 20, 2011

(54) Pistol for integrated administering a liquid and a compressing air flow

(76) Inventor: Johannes Oskar Rieger, Sao Paulo (BR)

(21) Appl. No.: 11/882,484

(22) Filed: Aug. 2, 2007

(30) Foreign Application Priority Data
Aug. 3, 2006 (BR) PI 060.3247-8
Feb. 6, 2007 (BR) MU 870.0238-8

(51) Int. Cl. B05B 9/01

(52) U.S. Cl. 239/526

(57) ABSTRACT

“PISTOL FOR INTEGRATED ADMINISTERING A LIQUID AND A COMPRESSING AIR FLOW”, which is presents a main model and a constructive variant; the main model comprises a monoblock body (1.1) embodied with a pistol produced in metal which counts on a handhold (1.2), a trigger (1.3) and a compression button (1.4); the monoblock body (1.1) includes a channel passage (1.5) that begins in the handhold (1.2) that gets to an assembling housing (1.6) wherein there is a shutter device or valve (1.7) that is activated by trigger (1.3); channels (1.5) and (1.11) in the lower edge of hand (1.2), finish in threaded connections (1.16) and (1.17) which are connected to hose (1.18) and (1.19), wherein flow, respectively, liquid under pressure and compressed air; valves (1.7) and (1.13) present same basic function, differing from just what refers to employed shutters, a sphere (1.7A), in valve (1.7) and a disc (1.13A) in valve (1.13); the constructive variant comprises a monoblock body (2.1) that counts on an angle handhold portion (2.2) that presents in its early region, an integral block (2.3), from which starts a structural project (2.4) in the edge wherein there is an sprinkler (2.5) and a tubular elongation (2.6); integral block (2.3) receives a valve or shutter (2.7) assembling that operates liquid flow and that is assembled next to another valve or shutter (2.8), the latter being responsible for operation of compressed air flow.

### FIELD OF INVENTION

The present invention of Privilege of Invention refers to a pistol specially developed to be used together with operative machines in general, a well as milling machines, lathes, and machining centers aiming at integrating in a single manual device the needed means to allow an integrated administration (simultaneous or alternate) or a liquid and a compressed air flow.

### BACKGROUND OF THE INVENTION

As it is common knowledge, operative machines such as milling machines, lathes, and others, or even machining centers, work raw blocks (normally metallic) so that to remove in controlled way small portions of material in order to obtain the desired component, thus generating a great volume of splinter as rebuff.

Tools functioning from operative machine (and congeners equipments) much depend on being maintained in a temperature suitable to the means of cut, rough-hew, etc, such condition is obtained before a constant liquid flow of cooling being directed to the region where the material is being effectively worked.

When a component is concluded, it is very common the machine operator needs to use a device that when connected to a hose is used to allow a liquid flush under pressure (normally liquid of cooling) being specially employed to clean the splinter part accumulated on it after finishing machining operation.

Another device similar to the first is used to allow application of compressed air flush aiming at allowing a first drying stage of component before it being removed from operative machine.

In general lines the devices allowing controlled application from both pressurized liquid flow and compressed air flow are independent and directly connected to respective hose. This fact results in the condition the machine operator has to alternatively handle one or another device, such fact being counter productive.

### BRIEF DESCRIPTION OF THE INVENTION

Due to this state of art, it was developed a pistol for integrated administering a pressurized liquid and a compressing air flow herein referred which allows integrating in a single anatomic device embodied in a pistol format needed means for administering a liquid flow that may be then used to promote newly produced component cleaning as well as the needed means to allow application for a compressed air flow that is, thus, used to produced the component drying.

The main model of pistol herein proposed is directly connected to a pair of hoses of supplying being a hose responsible by liquid feeding and another one responsible by air feeding. Pistol herein referred presents separated commands for each one of the two functions then allowing its operator to totally independently select liquid application function as well as compressed air flow application function. It is important to highlight the present patent of Privilege of Invention also presents besides main model of pistol for integrated administering a pressurized liquid and a compressing air flow, a varying model as to its constructive way, but such constructive variant also refers to the matter in question and it is derived from main model.

### BRIEF DESCRIPTION OF FIGURES

The main model and constructive varying of pistol for integrated administering a pressurized liquid and a compressing air flow, object of the present patent of Patent of Invention will be described in details referring to drawing hereinabove related, in which:

FIG. 1 illustrates a side view of the main model of pistol herein related, which presents regions of schematic partial cut wherein its internal embodiment may be better understood.

FIG. 2 schematically illustrates in a wide scale and partial cut the region of two shutter valves that are part of the pistol illustrated in FIG. 1;

FIG. 3 illustrates a view of wide scale and in partial cut of frontal region of pistol illustrated in FIG. 1;

FIG. 4 illustrates a view in a wide scale and in cut of region of the pistol handhold illustrated in figure;

FIG. 5 illustrates a general view of the pistol illustrated in FIG. 1, exemplifying the condition of activating its trigger;

FIG. 6 illustrates a perspective view of constructive variant of main pistol listed above;

FIG. 7 illustrates a side view of the illustrated pistol in FIG. 6;

FIG. 8 illustrates a cut view from FIG. 7 such as indicated by cut line A-A;

FIG. 9 illustrates a frontal view of the referred pistol such as indicated by arrow A from FIG. 6;

FIG. 10 illustrates a cut view from FIG. 9 such as indicated by cut line B-B;

FIG. 11 illustrates another cut view from FIG. 9 such as indicated by cut line C-C; and

FIG. 12 illustrates a perspective view of a sub-variant from the pistol illustrated in FIG. 6 which is given as final format and materialized from equipment now proposed.

### DETAILED DESCRIPTION OF INVENTION

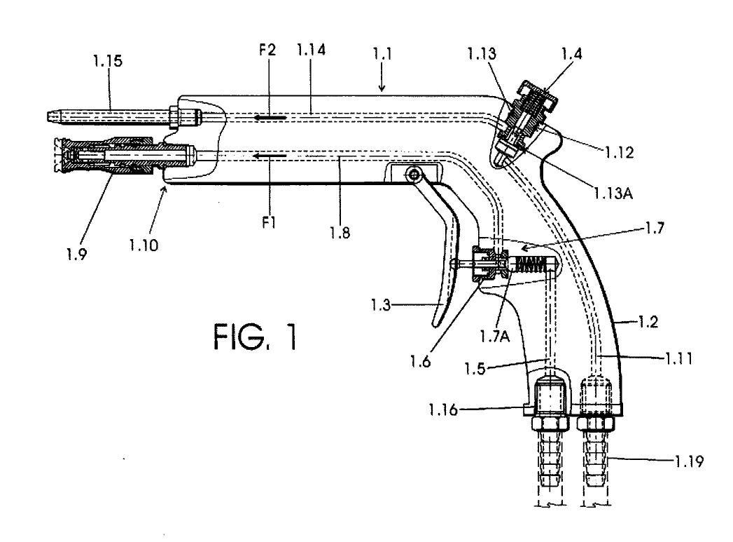

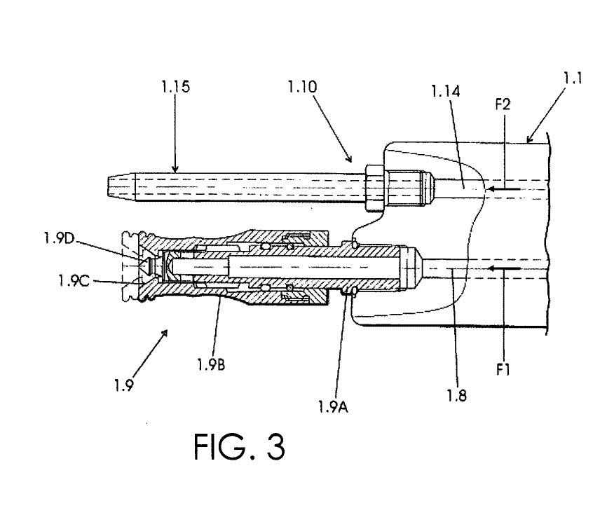

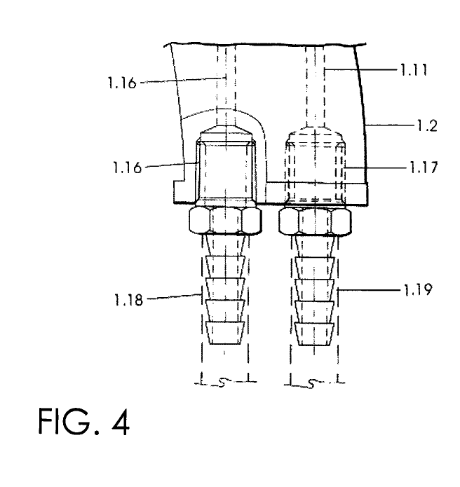

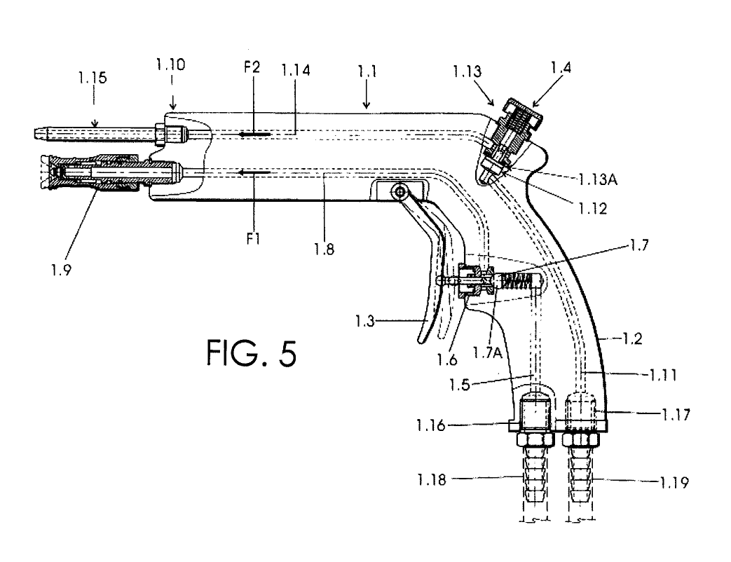

According to how much illustrate FIGS. 1-5, main model of pistol for integrated administering a pressurized liquid and a compressing air flow, object of the present invention of Privilege of Invention comprises a monoblock body 1.1 embodied as a pistol, preferably produced in metal which counts on a handhold 1.2, a trigger 1.3 and a compression button 1.4.

A monoblock body 1.1 includes a channel passage 1.5 that begins in the handhold 1.2 that gets to an assembling housing 1.6 wherein there is a shutter device or valve 1.7 that is activated by trigger 1.3. Channel 1.5 after valve 1.7 continues in a passage 1.8 that outflows in a sprinkler 1.9 that is assembled in the frontal edge 1.10 from monoblock body 1.1.

Same monoblock body 1.1 also includes a channel passage 1.11 that passes by handhold 1.2, gets to assemble housing 1.12 wherein there is a shutter device or valve 1.13 that is operated by a compression button 1.4.

After valve 1.13 it is contemplated a channel passage 1.14 that outflows in a tubular elongated 1.15, which is superiorly assembled in relation to sprinkler 1.9.

Channels 1.5 and 1.11 in the lower edge of handhold 1.2, finish in threaded connections 1.16 and 1.17 which are connected to hoses 1.18 and 1.19 wherein liquid under pressure and compressed air, respectively, flow.

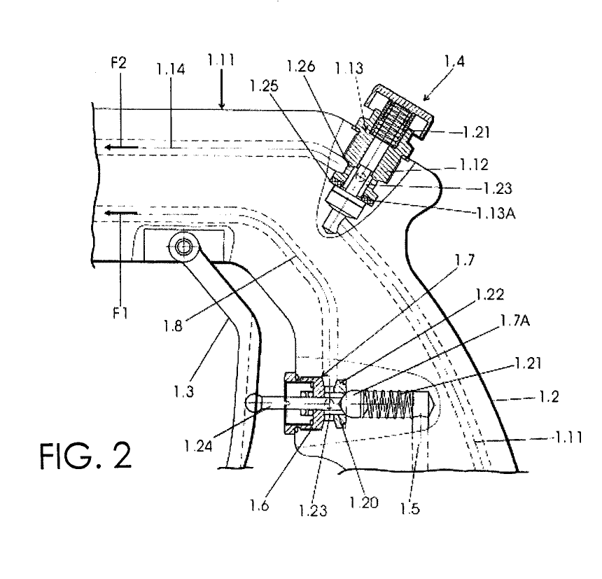

Valves 1.7 and 1.13 present it same basic function, differing from just what refers to employed shutters (a sphere 1.7A, in valve 1.7 and a disc 1.13A in valve 1.13), as it may be observed in FIG. 2, wherein both devices are retreated in wide scale.

Basic differences between valves 1.7 and 1.13 are also regarding to the fact the first one operates with liquid flow under pressure while the second one operates with compressed air.

In essence, valves 1.7 and 1.13 counts on a shutter element (1.7A and 1.13A) maintained against its respective local 1.20 by the action of respective spring 1.21. In valve 1.7, local 1.20 is integrant part of a valve 1.22 that includes an axial channel 1.23 that is crossed by shaft 1.24 operated by trigger 1.3.

In valve 1.13, local 1.25 is defined as a surface wherein disc 1.13A is maintained in spring function 1.21, being the referred disc operated when button 1.4 is pressed. Axial channel 1.23 counts on small radial channels that outflow in a ring recess 1.26 that rounds valve body 1.23.

The principle of valve operation 1.13 (that is the same principle of operation of valve 1.7) consists of when being compressed its shutter element will keep off from its local, thus allowing a flow (in this case compressed air) gets from channel 1.11 to channel 1.14, where such flow may effectively directed to pistol outlet, herein represented by tubular elongation 1.15.

Basic principle is also verified in relation to valve 1.7, which operates, as already mentioned, with liquid under pressure.

In FIGS. 1-5, F1 and F2 references indicate, respectively liquid and compressed air flow that cross pistol body.

Sprinkler 1.9, specially retreated in FIG. 2, presents a construction that allows adjustment of flow pattern induced to liquid flow, said sprinkler comprises a body 1.9A, which externally receives an adjustment component 1.9B that has in its conical opening 1.9C that is partially destroyed by a pin 1.9D, that takes a position related to function of positioning adjustment component 1.9B.

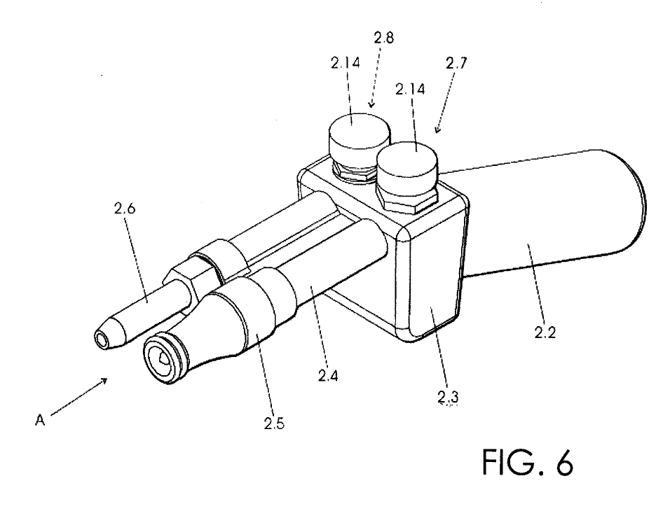

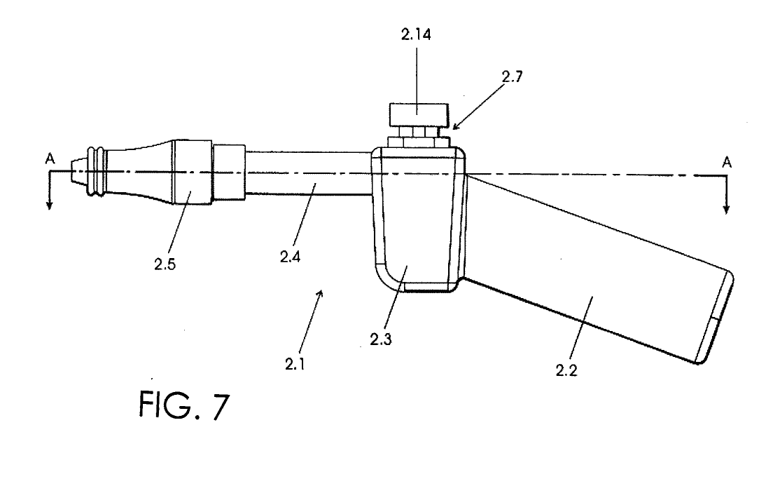

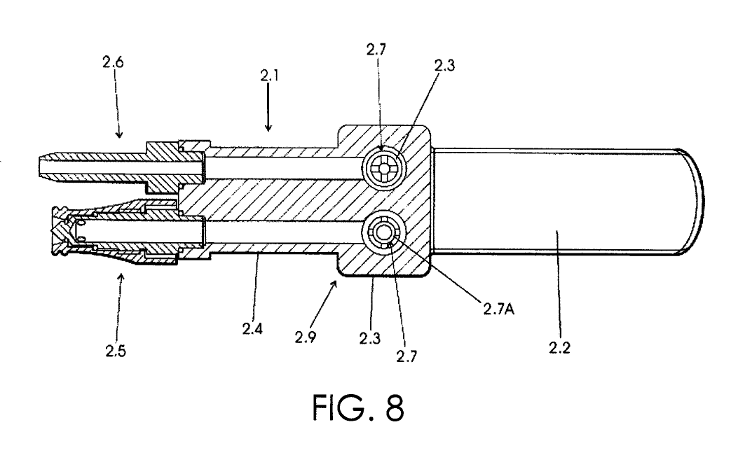

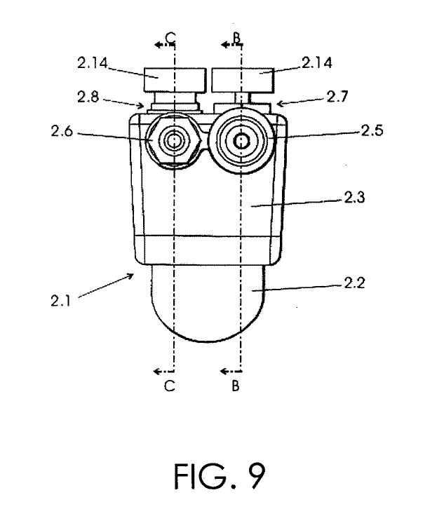

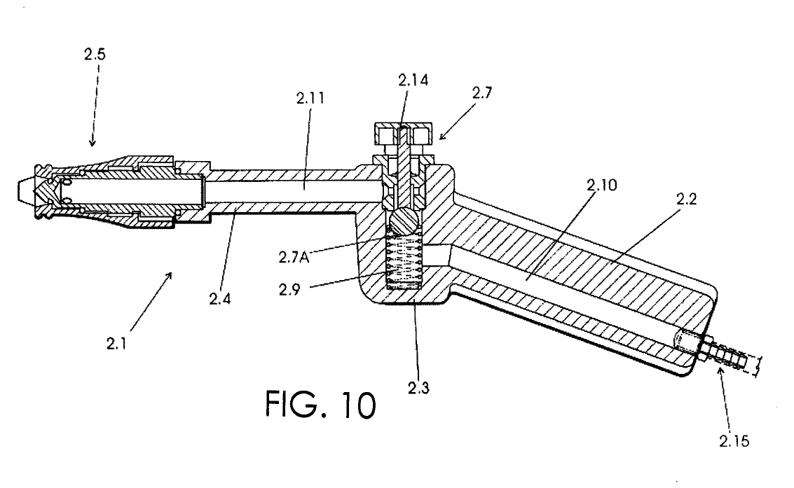

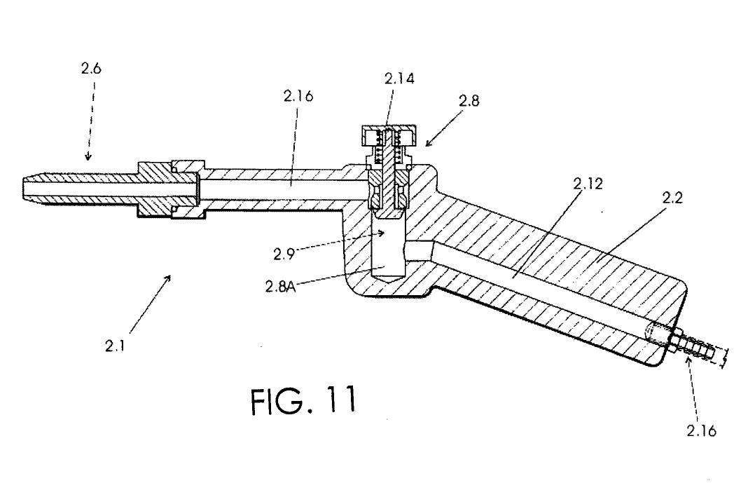

According to how much FIGS. 6-12, pistol constructive variant, also object of the present patent of Privilege of Invention, comprises a monoblock body 2.1 embodied to present an analogous format to a pistol, wherein referred main body 2.1 is preferably metallic.

Main body 2.1 counts on an angle handhold portion 2.2 that presents in its early region, an integral block 2.3, from which starts a structural project 2.4 in the edge wherein there is an sprinkler 2.5 and a tubular elongation 2.6.

Integral block 2.3 receives a valve or shutter 2.7 assembling that operates liquid flow and that is assembled next to another valve or shutter 2.8, the latter being responsible for operation of compressed air flow.

Valve or shutter 2.7 is assembled in central region 2.9 in integral block 2.3 in a housing 2.7A that is disposed in an intermediate format between a passage of a channel 2.10 that crosses the angle handhold 2.2, and a second channel passage 2.11 that crosses structural projection 2.4, and in the edge of said channel passage 2.11 there is an already mentioned sprinkler 2.5.

Another valve or shutter, indicated by numeric reference 2.8, is assembled in central region 2.9 of the same integral block 2.3, in a housing 2.8A, which is disposed as it happens with the housing 2.7A from valve and shutter 2.7 in an intermediate form between a channel passage 2.12 correspondent that crosses angle handhold 2.2 and a second channel passage 2.13 that crosses structural projection 2.4, and in the edge of said channel passage 2.13 there is the already mentioned tubular elongation 2.6.

Channel passages 2.10 and 2.11 run side aligned and mutually parallel along the angle handhold 2.2 while channel passages 2.11 and 2.13 also run side aligned mutually parallel along structural projection 2.4.

Valve or shutter 2.7 employed in the variant herein referred is preferably similar to valve used in main model of pistol previously detailed, and, differing from main model of pistol, valve and shutter 2.7 from constructive variant is not activated by a trigger but by a compression button 2.14, likewise compression button 2.14 that has an example exclusively assembled relating to valve or shutter 2.8 that is preferably likewise the one used in the main model of pistol, which is previously described.

Such as in the main model of pistol previously described. Also in the present constructive variant of pistol, it is contemplated thread connections (indicated by reference 2.15 and 2.16), that are coupled to angle handhold 2.2 and that serve to allow hose coupling (not illustrated), that feed pistol with distinctive flows of liquid and compressed air.

Operation system of the present pistol is exactly the same verified in the main model of pistol already described, not being needed then more detailed explanations.

Constructive variant of the main model of pistol results in a tool that presents a bigger practice of use since command for administering liquid flow and compressed air are disposed side by side and may be activated by operator before just use of his/her thumb.

Referred constructive variant of pistol now referred also presents a simpler construction regarding to its internal channels, fact that positively influences in a relative manufacturing cost reduction.

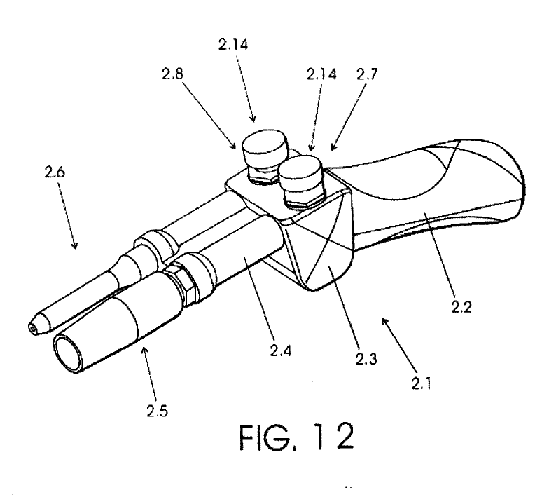

Pistol variant model now referred is illustrated in its version of materialization as showed in FIG. 12, such figure that allows the view of an already totally finished embodiment from instrument now proposed.

1. “PISTOL FOR INTEGRATED ADMINISTERING A LIQUID AND A COMPRESSING AIR FLOW”, which is characterized by the fact of comprising a monoblock body (1.1) embodied with a pistol, preferably produced in metal which counts on a handhold (1.2), a trigger (1.3) and a compression button (1.4); the monoblock body (1.1) includes a channel passage (1.5) that begins in the handhold (1.2) that gets to an assembling housing (1.6) wherein there is a shutter device or valve (1.7) that is activated by trigger (1.3); channel (1.5) after valve (1.7) continues in a passage (1.8) that outflows in a sprinkler (1.9) that is assembled in the frontal edge (1.10) from monoblock body (1.1); same monoblock body (1.1) also includes a channel passage (1.11) that passes by handhold (1.2), gets to assemble housing (1.12) wherein there is a shutter device or valve (1.13) that is operated by a compression button (1.4); after valve (1.13) it is contemplated a channel passage (1.14) that outflows in a tubular elongation (1.15) which is superiorly assembled in relation to sprinkler (1.9); channels (1.5) and (1.11) in the lower edge of hand (1.2), finish in threaded connections (1.16) and (1.17) which are connected to hose (1.18) and (1.19), wherein flow, respectively, liquid under pressure and compressed air; valves (1.7) and (1.13) present same basic function, differing from just what refers to employed shutters, a sphere (1.7A), in valve (1.7) and a disc (1.13A) in valve (1.13).

2. “PISTOL FOR INTEGRATED ADMINISTERING A LIQUID AND A COMPRESSING AIR FLOW”, according to claim 1, characterized by the fact that in valve (1.7), local (1.20) is integrant part of a valve (1.22) that includes an axial channel (1.23) that is crossed by shaft (1.24) operated by trigger (1.3) in valve (1.13), local (1.25) is defined as a surface wherein disc (1.13A) is maintained in spring function (1.21), being the referred disc operated when button (1.4) is pressed; axial channel (1.23) counts on small radial channels that outflow in an ring recess (1.26) that rounds valve body (1.23).

3. “PISTOL FOR INTEGRATED ADMINISTERING A LIQUID AND A COMPRESSING AIR FLOW”, according to claim 1, characterized by the fact that sprinkler (1.9), presents a construction that allows adjustment of flow pattern induced to liquid flow, said sprinkler comprises a body (1.9A), which externally receives an adjustment component (1.9B) that has in its conical opening (1.9C) that is partially destroyed by a pin (1.9D), that takes a position related to function of positioning adjustment component (1.9B).

4. “PISTOL FOR INTEGRATED ADMINISTERING A LIQUID AND A COMPRESSING AIR FLOW”, according to claim 1, characterized by the fact of contemplating a constructive variant of main model of pistol described in claims 1, 2, and 3; referred constructive variant comprises a monoblock body (2.1) characterized by the fact the main body (2.1) counts on an angle handhold portion (2.2) that presents in its early region, an integral block (2.3), from which starts a structural project (2.4) in the edge wherein there is an sprinkler (2.5) and a tubular elongation (2.6); Integral block (2.3) receives a valve or shutter (2.7) assembling that operates liquid flow and that is assembled next to another valve or shutter (2.8), the latter being responsible for operation of compressed air flow; valve or shutter (2.7) is assembled in central region (2.9) in integral block (2.3) in a housing (2.7A) that is disposed in an intermediate format between a passage of a channel (2.10) that crosses angle handhold (2.2), and a second channel passage (2.11) that crosses structural projection (2.4), wherein in the edge of said channel passage (2.11) there is an already mentioned sprinkler (2.5); another valve or shutter, indicated by numeric reference (2.8), is assembled in central region (2.9) integral block (2.3), in a housing (2.8A), which is disposed as it happens with the housing (2.7A) from valve and shutter (2.7) in an intermediate form between a channel passage correspondent (2.12) that crosses the angle handhold (2.2) and a second channel passage (2.13) that crosses structural projection (2.4), wherein in the edge of said channel passage (2.13) there is the already mentioned tubular elongation (2.6); channel passages (2.10) and (2.11) run side aligned and mutually parallel along the angle handhold (2.2) while channel passages (2.11) and (2.13) also run side aligned mutually parallel along structural projection (2.4); valve or shutter (2.7) is activated by a compression button (2.14) that has an example exclusively assembled relating to valve or shutter (2.8) that is preferably likewise the one used in the main model of pistol, which is previously described; it is contemplated thread connections (2.15) and (2.16), that are assembled in the edges of the channels (2.10) and (2.12), said thread connections (2.15) and (2.16) are used for coupling hoses that feed pistol with distinctive flows of air liquid and compressed air.
Operation system of the present pistol is exactly the same verified in the main model of pistol already described, not being needed then more detailed explanations.
Constructive variant of the main model of pistol results in a tool that present a bigger practice of use since command for administering liquid flow and compressed air are disposed side by side and may be activated by operator before just use of his/her thumb.
Referred constructive variant of pistol now referred also presents a simpler construction regarding to its internal channels, fact that positively influences in a relative manufacturing cost reduction.
Pistol variant model now referred is illustrated in its version of materialization as showed in FIG. 2.7, such figure that allows the view of an already totally finished embodiment from instrument now proposed.
